(19) United States
(12) Patent Application Publication
(10) Pub. No.: US 2018/0047231 A1
(43) Pub. Date: Feb. 15, 2018

(54) HISTORY MANAGEMENT SYSTEM OF ELECTRONIC LOCKING DEVICE

(71) Applicant: Bum Soo KIM, Namyangju-si, Gyeonggi-do (KR)

(72) Inventor: Bum Soo KIM, Namyangju-si, Gyeonggi-do (KR)

(21) Appl. No.: 15/554,091

(22) PCT Filed: Jul. 31, 2015
(86) PCT No.: PCT/KR2015/008074

§ 371 Date: Aug. 28, 2017

(30) Foreign Application Priority Data
Feb. 26, 2015 (KR) 10-2015-0027205

(51) Int. Cl. G07C 9/00; H04W 12/06; G06F 11/34

(52) U.S. Cl. CPC G07C 9/00309; G06F 11/3476; H04W 12/06; G07C 2009/0096; G07C 2009/00769

(57) ABSTRACT

The present disclosure relates to a history management system of an electronic locking device. According to the exemplary embodiment of the present disclosure, since the log information of an electronic key is transmitted from an electronic locking device to an external terminal through the electronic key or directly transmitted to the external terminal so that the manager can check the log information through the external terminal, and as a result, the manager can efficiently perform the history management of the electronic locking device and improving the security management efficiency of a used place of the electronic locking device.

### TECHNICAL FIELD

The present disclosure relates to a history management system of an electronic locking device.

### BACKGROUND ART

Generally, a locking device is installed in house drawers or furniture, public building, storage tools of commercial buildings, doors, lockers, and facilities to prepare for security.

Such a locking device for security is generally divided into a mechanical locking device and an electronic locking device, and in the case of a mechanical locking device, there is a problem of security due to the operation of a universal key and the like and there is a problem in that a locking device needs to be replaced when a key is lost.

Accordingly, in order to solve the problem of the mechanical locking device, the technology of the electronic locking device using an electronic key has been developed.

Meanwhile, as an example of such an electronic locking device, in Korean Patent Registration No. 10-1016903, disclosed is a “cylinder-type electronic locking device”.

However, in the electronic locking device disclosed above, only the hardware structure of a simple electronic locking device is disclosed, and a system capable of managing the history of the electronic key is not disclosed. Accordingly, development of a system in which a user can manage and check the history of an electronic key has been requested to satisfy user's security issue.

### DISCLOSURE

### Technical Problem

An object to be achieved by the present disclosure is to provide a history management system of an electronic locking device, in which since the log information of an electronic key is transmitted from an electronic locking device to an external terminal through the electronic key or directly transmitted to the external terminal so that the manager can check the log information through the external terminal, and as a result, the manager can efficiently perform the history management of the electronic locking device and improving the security management efficiency of a used place of the electronic locking device.

The objects of the present disclosure are not limited to the aforementioned effects, and other objects, which are not mentioned above, will be apparent to a person having ordinary skill in the art from the following description.

### Technical Solution

According to an aspect of the present disclosure, there is provided a history management system of an electronic locking device. The history management system of an electronic locking device includes a cylinder plug which is located inside a cylinder housing forming an appearance, installed rotatably in place, locked or unlocked to a cylinder housing, and detached from a key head of an electronic key, in which the cylinder plug includes a data communication unit which is electrically contacted with a terminal unit provided in the key head of the electronic key; and a data processing unit that determines authentication by comparing ID information of the electronic key transmitted by the data communication unit with a pre-stored ID database.

Further, the data processing unit may store log information about the authentication determined by comparing the ID information of the electronic key with the ID database and transmit the stored log information to a memory unit of the electronic key through the data communication unit.

Further, the data processing unit may transmit the log information to the memory unit of the electronic key and then delete or leave the stored log information according to a predetermined condition.

Further, the electronic key may include a data transmitting unit that transmits the log information stored in the memory unit to an external terminal.

Further, the data transmitting unit may be wiredly or wirelessly connected with the external terminal to transmit the log information to the external terminal.

According to another aspect of the present disclosure, there is provided a history management system of an electronic locking device. The history management system of an electronic locking device includes a receiving unit for receiving ID information of an electronic key; a processing unit for determining authentication by comparing the ID information transmitted from the receiving unit with a pre-stored ID database; a storage unit for storing log information about the authentication; and a transmitting unit for transmitting the log information stored in the storage unit to the electronic key or the external terminal.

Further, the log information may include log information about whether the electronic key is authenticated or not, log information about an open/close time by the authenticated electronic key, and log information about registration/change of a master electronic key.

Further, the log information stored in the storage unit may be transmitted to the electronic key or the external terminal through the transmitting unit and then deleted or left according to a predetermined condition.

### Advantageous Effects

According to the exemplary embodiment of the present disclosure, the log information of an electronic key is transmitted from an electronic locking device to an external terminal through the electronic key or directly transmitted to the external terminal so that the manager can check the log information through the external terminal, and as a result, the manager can efficiently perform the history management of the electronic locking device and improving the security management efficiency of a used place of the electronic locking device.

### DESCRIPTION OF DRAWINGS

FIG. 1 is a block diagram illustrating a history management system of an electronic locking device according to an exemplary embodiment of the present disclosure.

FIG. 2 is a perspective view illustrating an example of an electronic key and the electronic locking device of FIG. 1.

FIG. 3 is a cross-sectional view before and after coupling the electronic key and the electronic locking device of FIG. 2.

FIG. 4 is a block diagram illustrating a history management system of an electronic locking device for a plurality of electronic keys.

FIG. 5 is a block diagram illustrating a history management system of an electronic locking device according to another exemplary embodiment of the present disclosure.

### BEST MODE

Hereinafter, exemplary embodiments of the present disclosure will be described with reference to the accompanying drawings. First, in denoting reference numerals to constitutional elements of respective drawings, the same elements will be designated by the same reference numerals although they are shown in different drawings. Further, in the following description, a detailed explanation of known related technologies may be omitted to avoid unnecessarily obscuring the subject matter of the present disclosure.

Further, terms such as first, second, A, B, (a), (b), and the like may be used in describing the components of the exemplary embodiments according to the present disclosure. The terms are used to just distinguish the component from other components and the essence, sequence, or order of the corresponding component is not limited by the terms. When it is disclosed that any component is “connected”, “coupled”, or “linked” to other components, it should be understood that the component may be directly connected or linked to other components, but another component may be “connected”, “coupled”, or “linked” between the respective components.

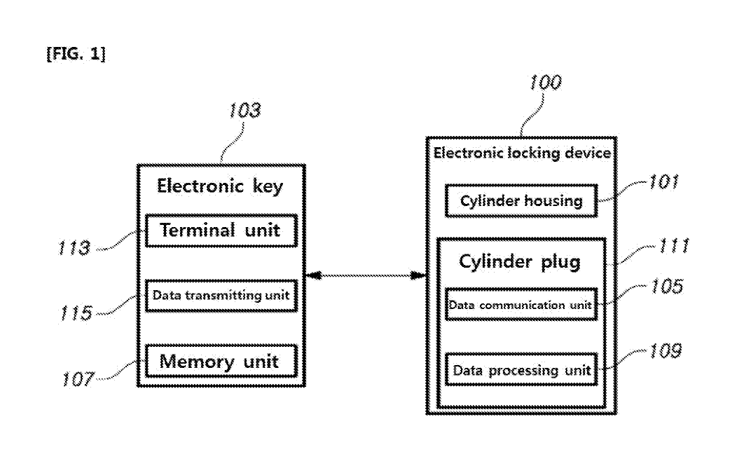

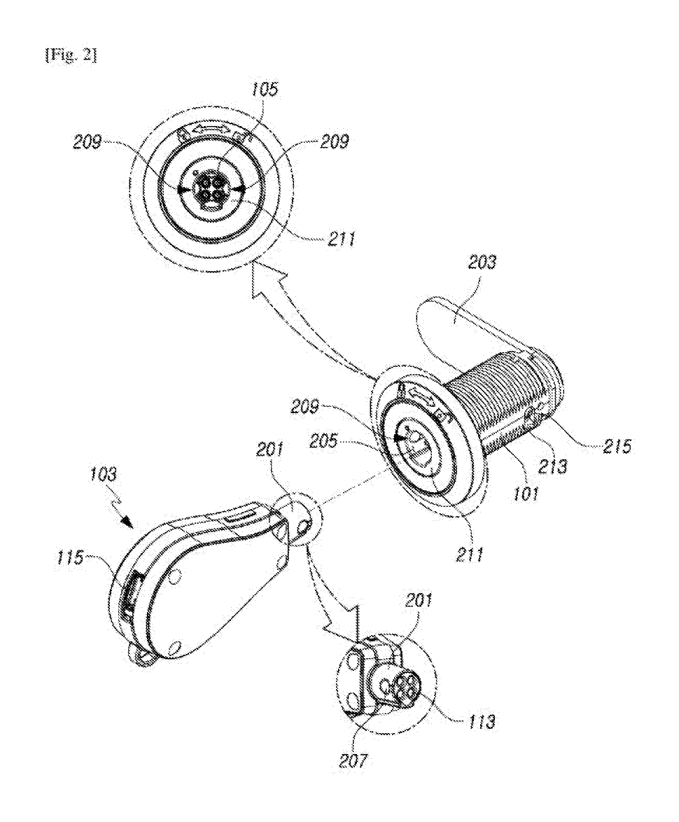

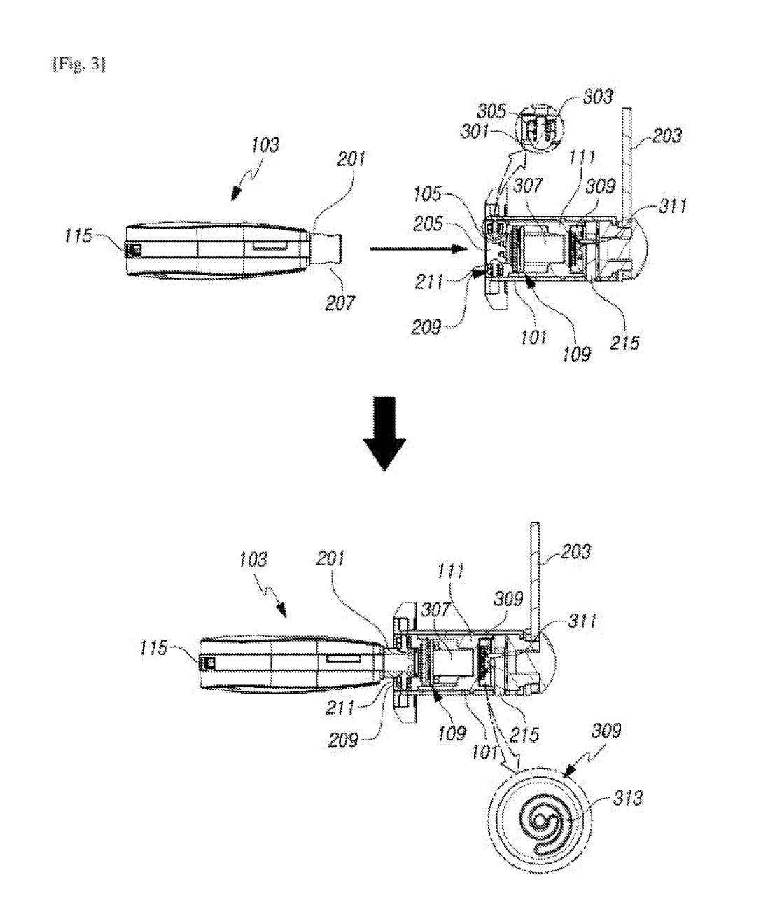

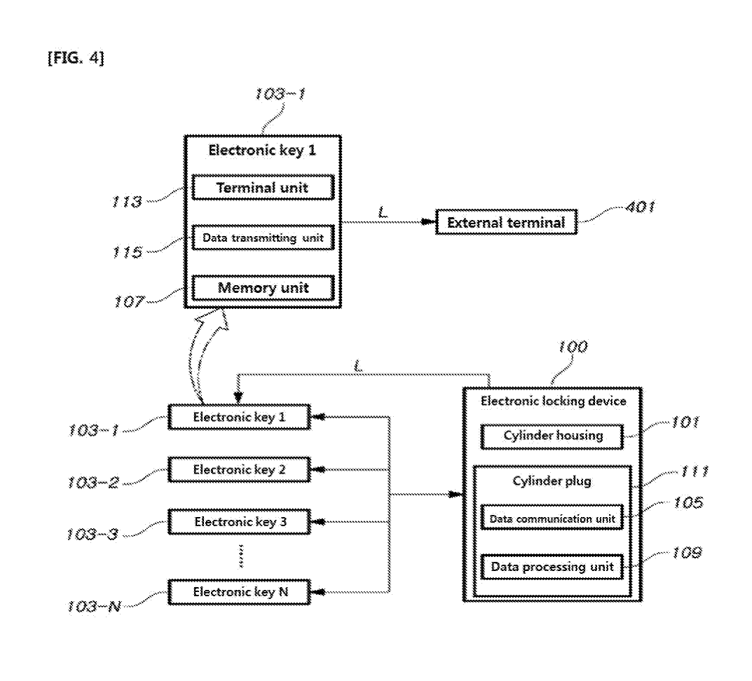

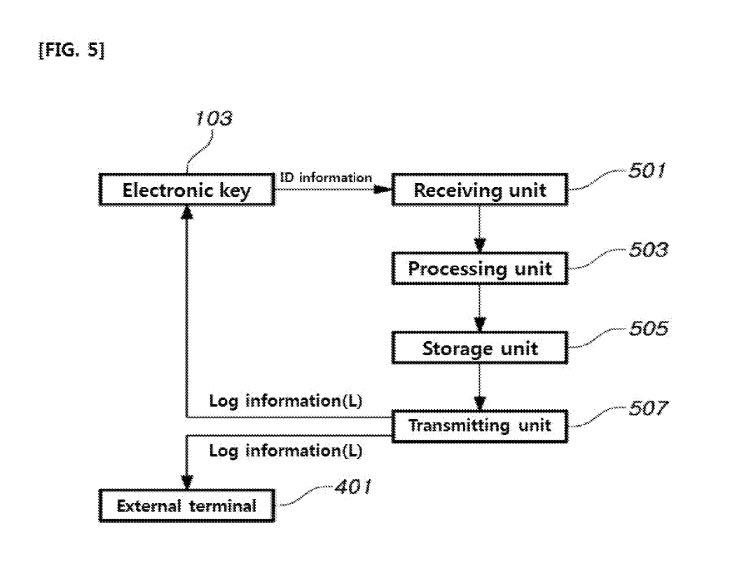

FIG. 1 is a block diagram illustrating a history management system of an electronic locking device according to an exemplary embodiment of the present disclosure. FIG. 2 is a perspective view illustrating an example of an electronic key and the electronic locking device of FIG. 1. FIG. 3 is a cross-sectional view before and after coupling the electronic key and the electronic locking device of FIG. 2. FIG. 4 is a block diagram illustrating a history management system of an electronic locking device for a plurality of electronic keys. FIG. 5 is a block diagram illustrating a history management system of an electronic locking device according to another exemplary embodiment of the present disclosure.

As illustrated in these drawings, a history management system of an electronic locking device 100 according to an exemplary embodiment of the present disclosure includes a cylinder plug 111 which is located inside a cylinder housing 101 forming an appearance, installed rotatably in place, locked or unlocked to the cylinder housing 101, and attached to and detached from a key head 201 of an electronic key 103. The cylinder plug 111 includes a data communication unit 105 which is electrically contacted with a terminal unit 113 provided in the key head 201 of the electronic key 103; and a data processing unit 109 that determines authentication by comparing ID information of the electronic key 103 transmitted by the data communication unit 105 with a pre-stored ID database.

First, a structure of the electronic locking device 100 will be described as an example.

The electronic locking device 100 includes the cylinder housing 101 and the cylinder plug 111.

The cylinder housing 101 forms the appearance, and the cylinder housing 101 has, for example, a hollow cylindrical shape, and a thread is formed on the outer circumferential surface of the cylinder housing 101 and may be screw-coupled with a coupling hole formed in a door or the like.

The cylinder plug 111 is located inside the cylinder housing 101 and rotatably installed in place, the cylinder plug 111 is locked or unlocked to the cylinder housing 101, and a latch bolt 203 is coupled with the cylinder plug 111 and rotated together according to the rotation of the cylinder plug 111.

Meanwhile, in such a cylinder plug 111, the data communication unit 105 which is detachably inserted with the key head 201 of the electronic key 103 and electrically contacted with the terminal unit 113 of the key head 201 is provided and a lock head 211 in which a second supporter 209 corresponding to a first supporter 207 formed in the key head 201 to fix the electronic key 103 is provided.

That is, in the lock head 211 provided in the cylinder plug 111, a key insertion hole 205 to which the key head 201 of the electronic key 103 is detachably inserted is formed, and a plurality of data communication units 105 is provided on the bottom (that is, an opposite surface in an opened direction) of the key insertion hole 205 and contacted with the terminal unit 113 provided in the key head 201 when the key head 201 of the electronic key 103 is inserted to the key insertion hole 205. Power and the ID information from the electronic key 103 are transmitted to the cylinder plug 111.

Meanwhile, in the lock head 211, the second supporter 209 is formed and corresponds to the first supporter 207 formed in the key head 201 of the electronic key 103 to fixedly support the key head 201 inserted to the key insertion hole 205.

When describing an example for the structure of the first supporter 207 and the second supporter 209 in detail, the first supporter 207 is formed on the outer circumferential surface of the key head 201 as a concavely recessed groove, and the second supporter 209 is provided on a circumferential surface of the key insertion hole 205 to which the key head 201 is inserted, corresponds to the first supporter 207, and may be formed as an elastically supported protrusion.

That is, the second supporter 209 may have a structure in which a head portion 301 exposed to the outside from the circumferential surface of the key insertion hole 205 is rounded and an elastic body 305 is coupled to the outer circumferential side of a guide shaft 303 integrally extended from the head 301.

Accordingly, when the key head 201 is inserted to the key insertion hole 205, the head 301 of the second supporter 209 is pressed and jumped out by the elastic restoring force of the elastic body 305 to press and support the first supporter 207 of the key head 201, thereby preventing the electronic key 103 from being easily detached from the cylinder plug 111.

The objects of forming the first supporter 207 and the second supporter 209 described above may also be interchanged, and that is, the first supporter 207 may be formed on the outer circumferential surface of the key head 201 as an elastically supported protrusion, and the second supporter 209 may be provided on a circumferential surface of the key insertion hole 205 to which the key head 201 is inserted to correspond to the first supporter 207 as a concavely recessed groove.

Meanwhile, the cylinder plug 111 includes the data processing unit 109 which performs a function of determining authentication by comparing ID information of the electronic key 103 transmitted by the data communication unit 105 with the pre-stored ID database, a function of storing log information L about the authentication, a function of transmitting the stored log information L to a memory unit 107 of the electronic key 103 via the data communication unit 105, and the like.

In the data processing unit 109, the ID database is pre-stored, and the data processing unit 109 determines authentication by comparing the ID information of the electronic key 103 transmitted by the data communication unit 105 with the ID database.

Only when the ID information of the electronic key 103 is authenticated, a process for the subsequent unlocking operation of the cylinder plug 111 proceeds.

Further, the data processing unit 109 stores log information L indicating whether the electronic key 103 is authenticated, and the log information L includes, for example, log information about whether the electronic key 103 is authenticated or not, log information about an open/close time by the authenticated electronic key 103, and log information about registration/change of a master electronic key.

Meanwhile, the data processing unit 109 transmits the log information L to the memory unit 107 of the electronic key 103 via the data communication unit 105, and in this case, the data processing unit 109 transmits the log information L to the memory unit 107 of the electronic key 103 and then deletes or leaves the stored log information L according to a predetermined condition.

That is, after the log information L is transmitted from the data processing unit 109 to the memory unit 107 of the electronic key 103, the log information L may be left in the data processing unit 109 or deleted and removed, which is determined by a predetermined condition in relation to whether the log information L is deleted.

In addition, the cylinder plug 111 includes a driver 307 that receives a control signal for the authenticating result of the data processing unit 109 to be driven forward or backward; and a lock pin 215 which is drawn into or out from the fixing hole 213 of the cylinder housing 101 according to the operation of the driver 307 and controls the rotation of the cylinder plug 111.

The driver 307 receives the control signal for the authenticating result of the data processing unit 109 to be driven forward or backward, and the driver 307 may be provided as, for example, an electric motor.

The lock pin 215 is drawn into or out from the fixing hole 213 of the cylinder housing 101 according to the operation of the driver 307 to control the rotation of the cylinder plug 111.

Herein, when describing the structure in which the lock pin 215 is operated according to the operation of the driver 307 in detail, a spur gear is coupled to a driving shaft of the driver 307, a direction switching rotary ring 309 having an internal gear formed on one side so that the spur gear is eccentrically inscribed and a spiral groove 313 formed at the other side is provided, and a moving shaft 311 of which one end is inserted into the spiral groove 313 and the other end is coupled with the lock pin 215 is provided. Accordingly, when the driving shaft is driven forward or backward according to the operation of the driver 307, the direction switching rotary ring 309 rotates in one direction or the other direction, and as a result, while the lock pin 215 moves along the spiral groove 313 of the direction switching rotary ring 309, the lock pin 215 moves forward or backward (that is, the lock pin 215 is drawn into or out from the fixing hole 213 of the cylinder housing 101), thereby controlling whether the cylinder plug 111 rotates in the cylinder housing 101.

Meanwhile, the electronic key 103 includes a data transmitting unit 115 that transmits the stored log information L transmitted from the data processing unit 109 of the cylinder plug 111 to the memory unit 107 to an external terminal 401, and the data transmitting unit 115 is wiredly or wirelessly connected with the external terminal 401 to transmit the log information L to the external terminal 401.

The functions (the function of receiving the log information L from the data processing unit 109 of the cylinder plug 111, the function of transmitting the log information L to the external terminal 401, and the like) of the electronic key 103 may be mounted on one electronic key selected from the plurality of electronic key in which the ID information is stored as a separate function.

An operation example of the history management system of the electronic locking device, which is the exemplary embodiment of the present disclosure, will be described with reference to the drawings.

When a plurality of electronic keys (electronic key 1 103-1 to electronic key N 103-N) are used in the cylinder plug 111 of the electronic lock device 100, log information L for each of the electronic key 1 103-1 to the electronic key N 103-N is stored in the data processing unit 109, and the log information L is, for example, downloaded in the memory unit 107 of the electronic key 1 103-1 to be transmitted to the external terminal 401 via the data transmitting unit 115.

Thereafter, the manager may check the history contents of the respective electronic keys (electronic key 1 103-1 to electronic key N 103-N) via the external terminal 401.

The above-described electronic key 1 103-1 may be a master key.

Meanwhile, a history management system of an electronic locking device according to another exemplary embodiment of the present disclosure includes a receiving unit 501 for receiving ID information of an electronic key 103; a processing unit 503 for determining authentication by comparing the ID information transmitted from the receiving unit 501 with a pre-stored ID database; a storage unit 505 for storing log information L about the authentication; and a transmitting unit 507 for transmitting the log information L stored in the storage unit 505 to the electronic key 103 or the external terminal 401.

The receiving unit 501 receives the ID information from the electronic key 103, and for example, the receiving unit 501 is electrically contacted with the terminal unit 113 provided in the key head 201 of the electronic key 103 to receive the ID information of the electronic key 103, and may also receive power from the electronic key 103.

Subsequently, the processing unit 503 determines whether the electronic key 103 is authenticated by comparing the ID information of the electronic key 103 transmitted from the receiving unit 501 with the pre-stored ID database.

Subsequently, the storage unit 505 stores the log information L about whether the electronic key 103 is authenticated which is determined by the processing unit 503, and the log information L includes, for example, log information about whether the electronic key 103 is authenticated or not, log information about an open/close time of the electronic locking key by the authenticated electronic key 103, and log information about registration/change of a master electronic key.

Subsequently, the transmitting unit 507 transmits the log information L stored in the storage unit 505 to the electronic key 103 or the external terminal 401, and the log information L may be transmitted between the transmitting unit 507 and the electronic key 103 or between the transmitting unit 507 and the external terminal 401, which are wiredly or wirelessly connected with each other.

The log information L is transmitted from the transmitting unit 507 to the electronic key 103, stored in the memory unit 107 of the electronic key 103, and then transmitted again to the external terminal 401 which is wirelessly or wiredly connected with the electronic key 103.

Meanwhile, the log information L stored in the storage unit 505 is transmitted to the electronic key 103 or the external terminal 401 through the transmitting unit 507 and then may be deleted or left according to a predetermined condition.

As described above, according to the exemplary embodiment of the present disclosure, since the log information of an electronic key is transmitted from an electronic locking device to an external terminal through the electronic key or directly transmitted to the external terminal so that the manager can check the log information through the external terminal, and as a result, the manager can efficiently perform the history management of the electronic locking device and improving the security management efficiency of a used place of the electronic locking device.

Hereinabove, even if it is described that all of constituent elements constituting the exemplary embodiment of the present disclosure are coupled as a single unit or coupled to be operated as a single unit, the present disclosure is not necessarily limited to the exemplary embodiment. That is, among the components, one or more constituent elements may be selectively coupled to be operated within the scope of the object of the present disclosure.

Further, the terms “including”, “comprising”, or “having” described above mean that the components may be included unless explicitly described to the contrary, and will be understood to imply the inclusion of stated elements but not the exclusion of any other elements. If it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

The above description just illustrates the technical spirit of the present disclosure and various modifications and transformations can be made by those skilled in the art without departing from an essential characteristic of the present disclosure. Therefore, the embodiments disclosed in the present disclosure are used to not limit but describe the technical spirit of the present disclosure and the scope of the technical spirit of the present disclosure is not limited by the embodiments. The scope of the present disclosure should be interpreted by the appended claims and all technical spirit in the equivalent range thereto should be interpreted to be embraced by the claims of the present disclosure.

1. A history management system of an electronic locking device comprising a cylinder plug which is located inside a cylinder housing forming an appearance, installed rotatably in place, locked or unlocked to a cylinder housing, and detached from a key head of an electronic key,
wherein the cylinder plug includes
a data communication unit which is electrically contacted with a terminal unit provided in the key head of the electronic key; and
a data processing unit that determines authentication by comparing ID information of the electronic key transmitted by the data communication unit with a pre-stored ID database.

2. The history management system of the electronic locking device of claim 1, wherein the data processing unit stores log information about the authentication determined by comparing the D information of the electronic key with the ID database and transmits the stored log information to a memory unit of the electronic key through the data communication unit.

3. The history management system of the electronic locking device of claim 2, wherein the data processing unit transmits the log information to the memory unit of the electronic key and then deletes or leaves the stored log information according to a predetermined condition.

4. The history management system of the electronic locking device of claim 2, wherein the electronic key includes a data transmitting unit that transmits the log information stored in the memory unit to an external terminal.

5. The history management system of the electronic locking device of claim 4, wherein the data transmitting unit is wiredly or wirelessly connected with the external terminal to transmit the log information to the external terminal.

6. A history management system of an electronic locking device comprising:
a receiving unit for receiving ID information of an electronic key;
a processing unit for determining authentication by comparing the ID information transmitted from the receiving unit with a pre-stored ID database;
a storage unit for storing log information about the authentication; and
a transmitting unit for transmitting the log information stored in the storage unit to the electronic key or the external terminal.

7. The history management system of the electronic locking device of claim 6, wherein the log information includes log information about whether the electronic key is authenticated or not, log information about an open/close time by the authenticated electronic key, and log information about registration/change of a master electronic key.

8. The history management system of the electronic locking device of claim 6, wherein the log information stored in the storage unit is transmitted to the electronic key or the external terminal through the transmitting unit and then deleted or left according to a predetermined condition.
